(19) United States
(12) Patent Application Publication
(10) Pub. No.: US 2019/0369460 A1
(43) Pub. Date: Dec. 5, 2019

(54) CAMERA LENS CONTROL DEVICE

(71) Applicant: Nihon Video System Co., Ltd., Tsushima-shi (JP)

(72) Inventor: Kentaro Hashiguchi, Tsushima-shi (JP)

(73) Assignee: Nihon Video System Co., Ltd., Tsushima-shi (JP)

(21) Appl. No.: 16/430,186

(22) Filed: Jun. 3, 2019

(30) Foreign Application Priority Data
Jun. 4, 2018 (JP) 2018-107175

(51) Int. Cl. G03B 7/01; H04N 5/247

(52) U.S. Cl. CPC G03B 7/01; H04N 5/247

(57) ABSTRACT

The purpose is to provide a camera lens control device that enables iris link between a plurality of cameras even when iris link using a CCU is not available. According to the present disclosure, provided is a camera lens control device comprising first and second control units that can communicate with each other, wherein the first control unit is configured to communicate with a first lens device attached to a first camera, the second control unit is configured to communicate with a second lens device attached to a second camera, the iris positions of the first and second lens devices are configured to change in conjunction with each other through communication of the first and second control units, and the first control unit is configured to communicate with the first lens device without passing through the first camera.

### FIELD OF THE INVENTION

The present invention relates to a camera lens control device that enables iris links between a plurality of cameras even when iris links using a CCU are not available.

### BACKGROUND OF THE INVENTION

In order to create a high-quality work, shooting using multiple video cameras may be performed. If these video cameras are high-end models of the same manufacturer, iris link using camera control unit (CCU) is installed, and it is possible to match iris positions of multiple video cameras using this function.

### SUMMARY OF THE INVENTION

However, when using multiple video cameras from different manufacturers, it is not easy to match the iris positions because the iris link using the CCU cannot be used.

The present invention has been made in view of such circumstances, and provides a camera lens control device that enables iris link between a plurality of cameras even when iris link using a CCU is not available.

According to the present invention, provided is a camera lens control device comprising first and second control units that can communicate with each other, wherein

the first control unit is configured to communicate with a first lens device attached to a first camera,

the second control unit is configured to communicate with a second lens device attached to a second camera,

the iris positions of the first and second lens devices are configured to change in conjunction with each other through communication of the first and second control units, and

the first control unit is configured to communicate with the first lens device without passing through the first camera.

In the present invention, the first control unit is configured to be able to communicate with the first lens device without passing through the first camera. Therefore, even if multiple cameras include cameras that cannot be controlled by the CCU, it is possible to construct an iris link.

The “camera” in the claims may be a video camera or a still camera. The movie mode of the still camera enables movie shooting. According to the present invention, an iris link between a plurality of cameras including a video camera and a still camera is possible.

Hereinafter, various embodiments of the present invention will be illustrated. The embodiments shown below can be combined with one another.

Preferably, the iris position of the second lens device is configured to change with the iris position of the first lens device.

Preferably, the second control unit is configured to control the iris position of the second lens device using a second iris control signal generated based on a first iris position signal output from the first lens device.

Preferably, the second iris control signal is a built-in electric mechanism control signal for controlling the iris position by a built-in electric mechanism.

Preferably, the second iris control signal is a motor control signal for controlling the iris position by rotating an iris adjustment ring by rotation of an external motor.

Preferably, the first control unit is configured to control the iris position of the first lens device using a first iris control signal generated by itself, and the second control unit is configured to control the iris position of the second lens device using a second iris control signal generated based on the first iris control signal.

Preferably, the first and second iris control signals are built-in electric mechanism control signals for controlling the iris positions by built-in electric mechanisms.

Preferably, one of the first and second iris control signals is a built-in electric mechanism control signal for controlling an iris position by a built-in electric mechanism, and the other of the first and second iris control signals is a motor control signal for controlling an iris position by rotating an iris adjustment ring by rotation of an external motor.

Preferably, the first control unit has a first parent unit and a first child unit that can communicate with each other, the first parent unit is configured to communicate with the first lens device without passing through the first camera, and the first child unit is a device configured to be able to communicate with the second control unit.

Preferably, the second control unit has a second parent unit and a second child unit that can communicate with each other, the second parent unit is configured to communicate with the second lens device without passing through the second camera, and the first child unit and the second child unit are configured to be able to communicate with each other.

Preferably, a third control unit is provided, and the third control unit is configured to communicate with a third lens device attached to a third camera, and the iris positions of the first to third lens devices are configured to change in conjunction with each other through communication of the first to third control units.

Preferably, the iris positions of the second and third lens devices change in conjunction with the iris position of the first lens device

Preferably, the third control unit is configured to communicate with the first control unit via the second control unit

### BRIEF DESCRIPTION OF THE DRAWINGS

FIG. 1 is a configuration diagram of a state in which an iris link between first and second camera units 21 and 22 is configured using a camera lens control device 1 according to a first embodiment of the present invention.

FIG. 2 is a configuration diagram of a state in which an iris link between three or more camera units is configured using a camera lens control device 1 according to a second embodiment of the present invention.

### DETAILED DESCRIPTION

Hereinafter, embodiments of the present invention will be described using the drawings. The various features shown in the embodiments described below can be combined with one another.

### 1. First Embodiment

1-1. Configuration

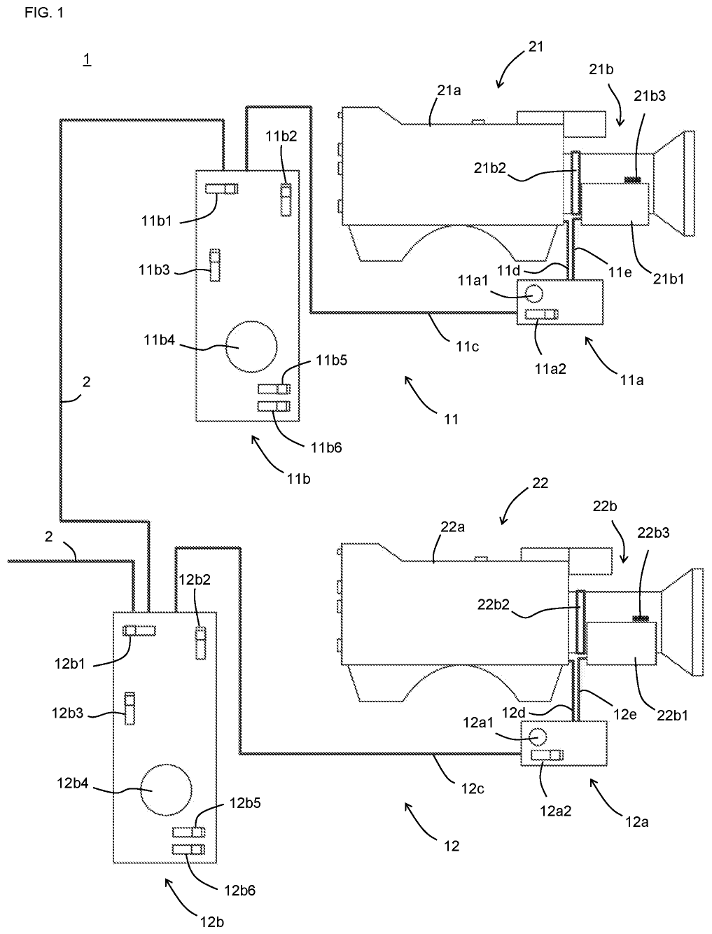

As shown in FIG. 1, the camera lens control device 1 of the present embodiment includes a first control unit 11 and a second control unit 12. The first and second control units 11 and 12 are provided corresponding to first and second camera units 21 and 22, respectively.

<First and Second Camera Units 21, 22>

The first camera unit 21 includes a first camera (video camera) 21a and a first lens device (lens) 21b. The first lens device 21b is attached to the first camera 21a. The first lens device 21b includes a lens grip 21b1, an iris adjustment ring 21b2, and an iris auto/manual selector switch 21b3. The iris auto/manual selector switch 21b3 is provided in the lens grip 21b1.

The second camera unit 22 is configured in the same manner as the first camera unit 21. The second camera unit 22 includes a second camera (video camera) 22a and a second lens device 22b. The second lens device 22b is attached to the second camera 22a. The second lens device 22b includes a lens grip 22b1, an iris adjustment ring 22b2, and an iris auto/manual selector switch 22b3. The iris auto/manual selector switch 22b3 is provided in the lens grip 22b1.

<First and Second Control Units 11, 12>

The first and second control units 11 and 12 can communicate with each other. The first control unit 11 is configured to communicate with the first lens device 21b. The second control unit 12 is configured to communicate with the second lens device 22b. The first and second control units 11 and 12 is configured to control the iris positions of the first and second lens devices 21b, 22b, respectively. The iris positions of the first and second lens devices 21b and 22b are changed in conjunction with each other through communication of the first and second control units 11 and 12. By this, iris link is realized. The first control unit 11 is configured to be able to communicate with the first lens device 21b without passing through the first camera 21a. The second control unit 12 is configured to be able to communicate with the second lens device 22b without passing through the second camera 22a.

The first control unit 11 is composed of a pair of a first parent unit 11a and a first child unit 11b. The first parent unit 11a and the first child unit 11b can communicate via the cable 11c. The first parent unit 11a has an iris volume control 11a1 and an auto iris/iris volume control selector switch 11a2.

The first child unit 11b includes a master/slave selector switch 11b1, a wired/wireless selector switch 11b2, an iris link ON/OFF selector switch 11b3, an iris volume control 11b4, an iris auto/manual selector switch 11b5, and a reflection switch 11b6. The first parent unit 11a can communicate with the first camera 21a through the cable 11d, and can communicate with the first lens device 21b through the cable 11e.

The second control unit 12 is configured in the same manner as the first control unit 11. The second control unit 12 is composed of a pair of a second parent unit 12a and a second child unit 12b. The second parent unit 12a and the second child unit 12b can communicate via the cable 12c. The second parent unit 12a has an iris volume control 12a1 and an auto iris/iris volume control selector switch 12a2.

The second child unit 12b includes a master/slave selector switch 12b1, a wired/wireless selector switch 12b2, an iris link ON/OFF selector switch 12b3, an iris volume control 12b4, an iris auto/manual selector switch 12b5, and a reflection switch 12b6. The second parent unit 12a can communicate with the second camera 22a through the cable 12d, and can communicate with the second lens device 22b through the cable 12e.

The child units 11b and 12b are configured to be communicable via the cable 2. The child unit 12b is connected to the cable 2 which is connected to another child unit of another control unit.

In the present embodiment, the communication between components is wired communication via cable, but may be wireless communication. Switching between wired and wireless can be performed by operating the selector switches 11b2 and 12b2.

The shape of the selector switch and the volume control is not particularly limited, and may be any form such as a slide type, a rotary type, or a button type.

1-2. How to Use

1-2-1. Iris Link Using the First Iris Position Signal Output from the First Lens Device 21b

The case where an iris link between the first and second camera units 21 and 22 is constructed using the first iris position signal output from the first lens device 21b will be described. Whether to perform iris link can be switched by operating the selector switches 11b3 or 12b3.

(1) Setting of Master/Slave

First, operate the selector switches 11b1 and 12b1 to set which of the first and second control units 11 and 12 is to be a master and which is to be a slave. Here, first control unit 11 is set to be a master and second control unit 12 is set to be a slave. In this case, the iris position of the second lens device 22b changes in conjunction with the iris position of the first lens device 21b.

(2) Auto/Manual Setting

By operating the selector switch 21b3 or the selector switch 11b5, it is set whether the iris position of the first lens device 21b is to be set to automatic control or to be set to manual control.

In the case of the automatic control, the iris position of the first lens device 21b is controlled by the auto signal (i.e. automatic iris position control signal) from the first camera 21a. This auto signal is output from the first lens device 21b as a first iris position signal, and input to the first control unit 11 (specifically, the first parent unit 11a). The first iris position signal is output from, for example, a terminal provided to the lens grip 21b1. The first iris position signal is, for example, a signal indicating the iris position by the magnitude of voltage. The auto signal may be directly input from the first camera 21a to the first parent unit 11a. In this case, the first parent unit 11a treats the auto signal as a first iris position signal.

When using manual control, the camera operator operates iris adjustment ring 21b2 to control the iris position of the first lens device 21b. Also in this case, the first iris position signal indicating the iris position is output from the first lens device 21b and input to the first parent unit 11a.

(3) Iris Link

By operating the reflection switch 11b6, the iris link can be started by reflecting the iris position of the first lens device 21b on the second lens device 22b. The second control unit 12 controls the iris position of the second lens device 22b using the second iris control signal generated based on the first iris position signal.

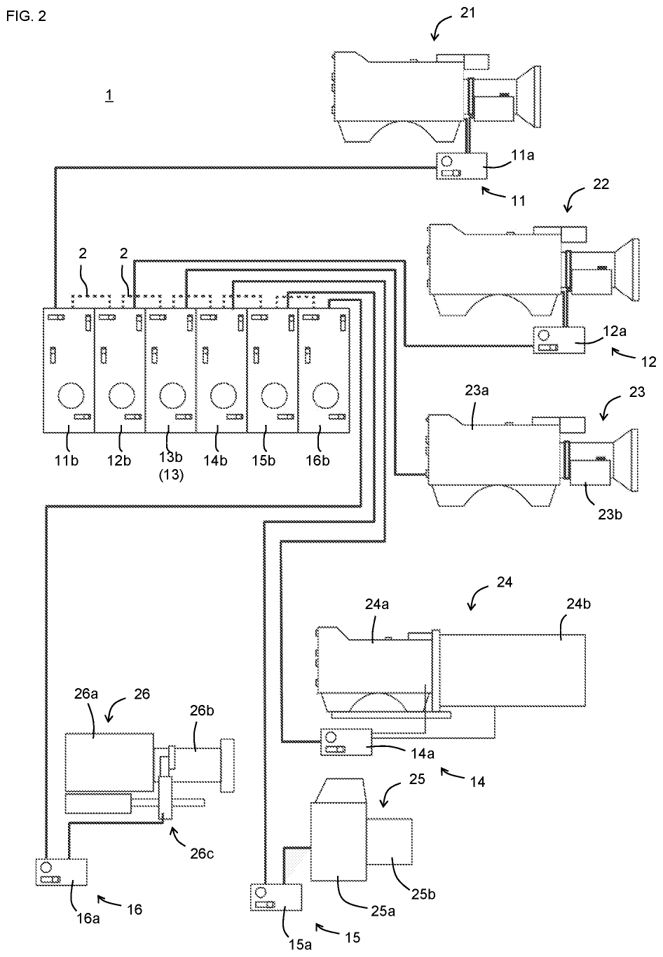

The second iris control signal is, for example, a signal indicating the iris position by the magnitude of voltage. The second iris control signal may be the same as or different from the first iris position signal. If the first and second lens devices 21b and 22b both control the iris position by built-in electric mechanism and make both iris positions the same, the second iris control signal can be matched with the first iris position signal. On the other hand, when the iris position of the second lens device 22b is made different from that of the first lens device 21b, a signal obtained by converting the first iris position signal can be used as the second iris control signal. Furthermore, if the second lens device 22b is such that the iris position is controlled by rotating the iris adjustment ring 22b2 by an external motor, as in the lens device 26b of FIG. 2, then the second iris control signal becomes a motor control signal generated based on the first iris position signal.

The second iris control signal is output from the second parent unit 12a. Information on iris position indicated by the first iris position signal is transmitted in the order of the first parent unit 11a, the first child unit 11b, the second child unit 12b, and the second parent unit 12a. Between these units, the first iris position signal or the second iris control signal may be transmitted as it is, or a signal converted from the first iris position signal may be transmitted.

By the above configuration, iris link using the first iris position signal is realized.

1-2-2. Iris Link Using First Iris Control Signal

The first control unit 11 can control the iris position of the lens device 21b using a first iris control signal. Hereinafter, the case of constructing an iris link between the first and second camera units 21 and 22 using the first iris control signal will be described. The description overlapping with “1-2-1” will be omitted as appropriate.

(1) Setting of Iris Position Control by First Control Unit 11

The selector switch 11a2 is operated to enable setting of the iris position of the first lens device 21b by the first control unit 11.

(2) Iris Link

In this state, when the iris volume control 11a1 or 11b4 is operated, the first iris control signal is output from the first control unit 11 (specifically, the first parent unit 11a), and is input to the first lens device 21b. The iris position of the first lens device 21b is controlled by the first iris control signal. The first iris control signal is, for example, a signal indicating the iris position by the magnitude of the voltage.

The second control unit 12 controls the iris position of the second lens device 22b using the second iris control signal generated based on the first iris control signal.

The second iris control signal may be the same as or different from the first iris control signal. If the first and second lens devices 21b and 22b both control the iris position by the built-in electric mechanism and the iris positions of both are the same, the second iris control signal matches with the first iris control signal. On the other hand, in the case where the iris position of the second lens device 22b is made different from that of the first lens device 21b, a signal obtained by appropriately converting the first iris control signal can be used as the second iris control signal. Furthermore, if the second lens device 22b is such that the iris position is controlled by rotating the iris adjustment ring 22b2 by an external motor, as in the lens device 26b of FIG. 2, then the second iris control signal becomes a motor control signal generated based on the first iris control signal.

The second iris control signal is output from the second parent unit 12a. The information on the iris position indicated by the first iris control signal is transmitted in the order of the first parent unit 11a, the first child unit 11b, the second child unit 12b, and the second parent unit 12a. Between these units, the first iris control signal or the second iris control signal may be transmitted as it is, or a signal converted from the first iris control signal may be transmitted.

With the above configuration, an iris link using the first iris control signal is realized.

### 2. Second Embodiment

The second embodiment of the present invention will be described using FIG. 2. The present embodiment is similar to the first embodiment, and hereinafter differences therebetween will be mainly described.

The camera lens control device 1 of the present embodiment includes third to sixth control units 13 to 16 in addition to the configuration of the first embodiment. The third to sixth control units 13 to 16 are provided corresponding to the third to sixth camera units 23 to 26, and communicate with third to sixth lens devices 23b to 26b attached to third to sixth camera 23a to 26a, respectively. The third to sixth control units 13 to 16 control the iris positions of the third to sixth lens devices 23b to 26b using third to sixth iris control signals, respectively. The iris positions of the first to sixth lens devices 21b to 26b are changed in conjunction with each other by an iris link realized by the camera lens control device 1. Also, when the first control unit 11 is a master and the remaining control units are slaves, the iris positions of the second to sixth lens devices 22b to 26b change in conjunction with the iris position of the first lens device 21b.

The third control unit 13 includes a third child unit 13b, which has the same configuration as the first child unit 11b. The fourth control unit 14 is composed of a fourth parent unit 14a and a fourth child unit 14b, which have the same configuration as the first parent unit 11a and the first child unit 11b. The fifth control unit 15 comprises a fifth parent unit 15a and a fifth child unit 15b, which have the same configuration as the first parent unit 11a and the first child unit 11b. The sixth control unit 16 is composed of a sixth parent unit 16a and a sixth child unit 16b, which have the same configuration as the first parent unit 11a and the first child unit 11b.

The first to sixth child units 11b to 16b can communicate with each other. In addition, these are configured as daisy chains by connecting two adjacent child units with each other via a cable 2, and transmit signals in order. Thus, for example, the third control unit 13 communicates with the first control unit 11 via the second control unit 12. In one example, a daisy chain can be realized by providing a terminal for linking with another child unit on the side panel of the child unit.

The third camera unit 23 has a configuration in which the iris position of the third lens device 23b is controlled via the third camera 23a, and the third iris control signal from the third control unit 13 is input to the third camera 23a.

The fourth lens device 24b is a box-shaped lens, but even with such a lens, the iris position can be controlled similarly to the first lens device 21b.

The fifth camera unit 25 is a still camera, and it is possible to shoot a movie in the movie mode. The fifth camera unit 25 is a configuration in which the iris position of the fifth lens device 25b is controlled via the fifth camera 25a. Control of the iris position can be performed by a LANC signal or an analog iris signal. Therefore, the fifth iris control signal from the parent unit 15a of the fifth control unit 15 is input to the fifth camera 25a.

The sixth lens device 26b of the sixth camera unit 26 is a lens (e.g., PL lens) device that controls the iris position by rotating an external motor 26c that rotates the iris adjustment ring. According to this mechanism, even if the lens device does not have a built-in electric mechanism, the iris position of the lens device can be controlled electrically, and the realization of an iris link including such a lens device becomes possible. Such a mechanism is disclosed, for example, in JP-A-2016-103019.

### 3. Other Embodiments

The present invention can also be practiced in the following modes.

The first and second control units 11 and 12 may be configured as one device like the third control unit 13.

There may be included a function to store the iris position at that time when a predetermined operation is performed. Moreover, there may be provided a function to reproduce the iris position, when predetermined operation is performed.

### DESCRIPTION OF REFERENCE SIGNS

1: camera lens control device
2: cable
11: first control unit
11a: first parent unit
11a1: iris volume control
11a2: auto iris/iris volume control selector switch
11b: first child unit
11b1: master/slave selector switch
11b2: wired/wireless selector switch
11b3: iris link ON/OFF selector switch
11b4: iris volume control
11b5: iris auto/manual selector switch
11b6: reflection switch
11c: cable
11d: cable
11e: cable
12: second control unit
12a: second parent unit
12a1: iris volume control
12a2: auto iris/iris volume control selector switch
12b: first child unit
12b1: master/slave selector switch
12b2: wired/wireless selector switch
12b3: iris link ON/OFF selector switch
12b4: iris volume control
12b5: iris auto/manual selector switch
12b6: reflection switch
12c: cable
12d: cable
12e: cable
13: third control unit
13b: third child unit
14: fourth control unit
14a: fourth parent unit
14b: fourth child unit
15: fifth control unit
15a: fifth parent unit
15b: fifth child unit
16: sixth control unit
16a: sixth parent unit
16b: sixth child unit
21: first camera unit
21a: first camera
21b: first lens device
21b1: lens grip
21b2: iris adjustment ring
21b3: iris auto/manual selector switch
22: second camera unit
22a: second camera
22b: second lens device
22b1: lens grip
22b2: iris adjustment ring
22b3: iris auto/manual selector switch
23: third camera unit
23a: third camera
23b: third lens device
24: fourth camera unit
24a: fourth camera
24b: fourth lens device
25: fifth camera unit
25a: fifth camera
25b: fifth lens device
26: sixth camera unit
26a: sixth camera
26b: sixth lens device
26c: external motor

The embodiments of the invention in which an exclusive property or privilege is claimed are defined as follows:

1. A camera lens control device comprising first and second control units that can communicate with each other, wherein
the first control unit is configured to communicate with a first lens device attached to a first camera,
the second control unit is configured to communicate with a second lens device attached to a second camera,
the iris positions of the first and second lens devices are configured to change in conjunction with each other through communication of the first and second control units, and
the first control unit is configured to communicate with the first lens device without passing through the first camera.

2. The device of claim 1, wherein the iris position of the second lens device is configured to change with the iris position of the first lens device.

3. The device of claim 2, wherein the second control unit is configured to control the iris position of the second lens device using a second iris control signal generated based on a first iris position signal output from the first lens device.

4. The device of claim 3, wherein the second iris control signal is a built-in electric mechanism control signal for controlling the iris position by a built-in electric mechanism.

5. The device of claim 3, wherein the second iris control signal is a motor control signal for controlling the iris position by rotating an iris adjustment ring by rotation of an external motor.

6. The device of claim 2, wherein
the first control unit is configured to control the iris position of the first lens device using a first iris control signal generated by itself, and
the second control unit is configured to control the iris position of the second lens device using a second iris control signal generated based on the first iris control signal.

7. The device of claim 6, wherein the first and second iris control signals are built-in electric mechanism control signals for controlling the iris positions by built-in electric mechanisms.

8. The device of claim 6, wherein
one of the first and second iris control signals is a built-in electric mechanism control signal for controlling an iris position by a built-in electric mechanism, and
the other of the first and second iris control signals is a motor control signal for controlling an iris position by rotating an iris adjustment ring by rotation of an external motor.

9. The device of claim 1, wherein
the first control unit has a first parent unit and a first child unit that can communicate with each other,
the first parent unit is configured to communicate with the first lens device without passing through the first camera, and
the first child unit is a device configured to be able to communicate with the second control unit.

10. The device of claim 9, wherein
the second control unit has a second parent unit and a second child unit that can communicate with each other,
the second parent unit is configured to communicate with the second lens device without passing through the second camera, and
the first child unit and the second child unit are configured to be able to communicate with each other.

11. The device of claim 1, further comprising a third control unit, wherein the third control unit is configured to communicate with a third lens device attached to a third camera, and the iris positions of the first to third lens devices are configured to change in conjunction with each other through communication of the first to third control units.

12. The device of claim 11, wherein the iris positions of the second and third lens devices change in conjunction with the iris position of the first lens device.

13. The device of claim 11, wherein the third control unit is configured to communicate with the first control unit via the second control unit.
